(19) United States
(12) Patent Application Publication
(10) Pub. No.: US 2014/0114776 A1
(43) Pub. Date: Apr. 24, 2014

(54) System and Method for Obtaining Services at a Service Point Using a Mobile Device

(71) Applicants: Kaushal Solanki, Woodland Hills, CA (US); Shraddha Kacha, Woodland Hills, CA (US); Sinjeet Parekh, Sunnyvale, CA (US)

(72) Inventors: Kaushal Solanki, Woodland Hills, CA (US); Shraddha Kacha, Woodland Hills, CA (US); Sinjeet Parekh, Sunnyvale, CA (US)

(21) Appl. No.: 13/729,161

(22) Filed: Dec. 28, 2012

Related U.S. Application Data
(60) Provisional application No. 61/582,333, filed on Dec. 31, 2011.

(51) Int. Cl. G06Q 30/06; H04W 4/02

(52) U.S. Cl. CPC G06Q 30/0613; H04W 4/02
USPC 705/15; 705/26.41

(57) ABSTRACT

In this nonprovisional utility patent application, we describe a system and method for enabling micro check-in, which is defined as the process by which a user can selectively reveal her location at a service point in order to obtain specific services from a service provider. The invention is characterized by three unique, novel, traits: (a) the check-in (location revelation) happens at a fine resolution not possible by GPS-based sensors, (b) definition of specific service points, and (c) provision of a service or utility at the service point or elsewhere by the service provider. This represents the novelty of the invention with respect to the prior art, and also allow several new uses described in this application.

In one embodiment we describe a system and method for ordering food from a restaurant table using a smartphone. We also describe several other embodiments for a variety of domains.

### CROSS-REFERENCE TO RELATED APPLICATIONS

This application claims the benefit of PPA application number 61582333, filed 2011, Dec. 31, by the present inventors, which is incorporated by reference.

### FEDERALLY SPONSORED RESEARCH

Not Applicable

### SEQUENCE LISTING OR PROGRAM

Not Applicable

### BACKGROUND OF THE INVENTION

1. Field

This application relates generally to the field of mobile and web computing. Specifically it relates to the use of mobile devices to obtain services from a service provider.

2. Prior Art

Mobile computers such as smartphones and tablets are gaining a lot of popularity among consumers. Smartphone is a high-end mobile phone built on a mobile computing platform, with advanced computing ability and connectivity. Smartphones are redefining a number of our day-to-day activities as well as the way we get our entertainment. With emergence of this highly portable device with several capabilities including full-motion cameras, bright and large high-density screens, music player, email client, global positioning systems (GPS), Wi-Fi, 3G/4G data connectivity, innovative new applications have become available, and are collectively changing our lives for better.

For example U.S. patents 20120253902 to Carney II, 20120095791 to Stefik et. al. and U.S. Pat. No. 7,761,463 to Wheeler, all offer a variety of services that make use of the above mentioned technologies.

Of the said applications, social location check-in applications are becoming quite popular (for example, check popular applications such as FOURSQUARE).

U.S. patent 20120233158 to Braginsky et. al. enables users to automatically check-in based on the user's past location data. The term check-in is defined as revealing one's location to public or a selected few. People reveal their location based on GPS receivers for several purposes, including connecting with friends, earning rewards and badges, and getting special promotions. U.S. patent 20,120,209,685 to Nealer et. al. (2012) is similar to previous existing GPS based check-in applications with the added advantage of anonymously checking-in to commercial establishments and further allows the merchants to provide targeted offers to customers based on contextual data associated with the user.

There are several disadvantages of the GPS-based check-in services, as listed below.

1. Limited applications: Due to a limited accuracy of location provided by GPS based technology, there are only a small number of utilities that can be provided by GPS based check-in applications. These include (i) revealing location to alert friends (social), (ii) earn badges, (iii) earn rewards, and (iv) track whereabouts of people, especially children.
2. No provision of service: When a service provider, such as a local restaurant, engages with its customer via a GPS based check-in method, it opens a one-way engagement from the customer. This is a disadvantage because the local restaurant or business cannot provide services directly since the exact location of the customer within the local business is unknown.
3. Little incentive for involvement by the service provider: The value addition provided by a GPS-based check-in service to the local business is relatively low. Other than pushing special deals to attract a customer, they cannot do anything more.
Prior existing applications like Foursquare, Shopkick and U.S. patent 20120209685 to Nealer et. al. only provide checking-in to a commercial establishment at a macro level and the owner/service provider at the commercial establishment is unable to accurately determine the presence of the user at a finer resolution.

Among all these local businesses, restaurants represent a large market with clear need to engage with customers and provide better service to them via their smartphones. A restaurant is a place where people prepare and serve food, drinks, and desserts to patrons in exchange for money. There are many types of restaurants including formal, semi formal, casual and semi casual, fast food, lunch spots, hotel restaurants, breakfast diners, pizza joints and take out. Full-service restaurants provide the traditional dine-in experience to the patrons. In these full-service restaurants, a server takes the order and passes it on to the kitchen. The food is then prepared and served to the customer.

The concept of restaurants is centuries old and has a rich history. They have greatly evolved over the years, and technology has played an important role in how this evolution has taken shape. Over the past decades, the use of computers and customized software to manage customers and inventory has greatly simplified and streamlined restaurant operations. Point of sales (POS) software helps restaurant staff enter and process orders, and has become a nearly-essential component of restaurant management. With the advent and popularity of the Internet, several restaurant and food-related applications have become available in the market, including restaurant reservation, online food ordering (GRUBHUB), restaurant reviewing/rating (YELP), and locating restaurants using GPS (GOOGLE MAPS). The restaurant industry is now opening up to adopt new technologies to make their customer's experience better as is evident from U.S. Pat. No. 5,969,968 to Pentel. This is also influenced by changing expectations of the customers who have grown more and more accustomed to using their smartphones for variety of tasks. The traditional song and dance experience where the customer takes their seats, waits, orders food/drinks, again wait for food to arrive, eats food, and finally waits to get their check, is frustrating, particularly during peak hours.

To address these problems several companies have started providing tablet computers to be placed on a table of restaurants. Customers can see the menu on the tablets and place an order. These services however suffer from several disadvantages.

1. Cost of setup: There is significant initial investment for the restaurants. They typically either buy the tablets or rent them. Either way, the cost to the restaurant is significant.
2. Maintenance overhead: The devices also need to be maintained by performing actions such as updating the software, checking for hardware failures and fixing it.
3. Difficult to change or update the menu: Restaurants frequently change or update menu based on seasons or on chefs specials. Making these changes on each tablet is not a straightforward task. This significantly limits the use by restaurants who change their menus frequently.
4. Need to protect against theft: The tablets are small but expensive devices and they need to be secured against theft. There is no straightforward solution to this problem other than to physically securing the device against the table or attaching radio frequency identification (RFID) tags and checking devices.
U.S. Pat. No. 7,061,383 to Davis et. al. relates to RF check-in and is pertaining to automatic check-in for mass transits but no embodiment relating to ordering in a restaurant exists.
5. Everyone cannot order at once: A significant limitation of placing a tablet device each on a table is that customers at a table still need to wait for their turn since only one person can look at the menu and place order at one time.

Accordingly, what is desired, and not heretofore been developed, is a system where users can place order at a restaurant table without need for significant investment from the restaurants. Furthermore, what is desired, and not heretofore been developed, is a system that allows every user at a restaurant table to look at the menu and place order on his or her own, preferably from their mobile devices. U.S. Pat. No. 5,969,968 to Pentel involves ordering from a menu and uses a transmitter and receiver to transmit customer order. There is no concept of checking-in at any level.

U.S. Pat. No. 5,845,263 to Camaisa et. al. involves interactive ordering from a menu but the user does not have to reveal his presence at the table. The system captures the ordered item and tabulates the bill.
W.O. patent 2012135896(A1) to Bressan et. al. describes the method of ordering using a mobile display device but does not exploit the concept of check-in.

### SUMMARY

This application describes a system that allows a user to interact with a service provider at a service point via the use of their mobile device. A service provider can designate specific points as service points where the user can reveal his or her location using a mobile device. This action (or revealing user's location) establishes a communication channel between the service provider and the user, allowing the user to request specific services and obtain the service. In one embodiment, the service provider is a restaurant, the user is restaurant's customer, and the service point is restaurant table.

Using the method and system disclosed in this application, the user can reveal his location at the restaurant table, allowing him to order food. The system described in this application enables the order to be seen by the restaurant staff including the exact table this order came from. The restaurant staff can then prepare and serve the food to the correct table.

### BRIEF DESCRIPTION OF DRAWING

FIG. 1 shows a system that allows a user to reveal his or her presence at a service point, which allows the service provider to render requested service to the user.

FIG. 2 shows a flowchart that describes the process that is followed by a user and a service provider to request and provision services respectively. This is based on the user revealing location at high resolution (the process is termed \micro check-in”) to receive service(s) at a point of service.

FIG. 3 shows the architectures of a software system that can enable micro check-in, the process of revealing user's location at a finely-defined service point, and subsequent provision of service from the provider.

FIG. 4 shows the functional block diagram of a general micro check-in based system that allows a user to micro check-in at a service point, obtain a list of available services, and request specific services. The service provider sees the service request, and processes and provisions the service to the user.

FIG. 5 shows the workflow that describes steps for the user requesting service at a point of service using a mobile device.

FIG. 6 shows the flowchart that describes the workflow for the service provider once a service request arrives from a user who has already micro checked-in at a service point and has requested specific services.

FIG. 7 shows the setup for an embodiment of the invention disclosed in this application that allows a patron to order food from a restaurant table and the restaurant staff to serve food.

FIG. 8 shows the flowchart describing the workflow of using micro check-in, the invention disclosed in this application, at a restaurant table.

FIG. 9 shows functional block diagram of a system that allows users to order food from a restaurant table using their mobile devices.

FIG. 10 shows the steps for the user ordering food at a restaurant table using a mobile device.

FIG. 11 shows the flowchart that describes the workflow for the restaurant once an order arrives from a user who has already micro checked-in at a table.

FIG. 12 shows how a user can browse selected restaurant's menu on a mobile device. The user can also look at the different categories of food in the menu. User also gets a chance to add items to the tray.

FIG. 13 shows how a user can reveal his or her location at a table. Once a user decides to place an order, he/she must scan the QR code placed on the table. A web server will verify the order request based on user's QR code data and the location data.

FIG. 14 shows an example interface to manage favorites. The user can add a dish to his/her favorites. He or she can add notes and optionally take a picture of the favorite-ed dish. He/she can also share it with friends on social media.

FIG. 15 shows how a user, once micro checked-in to a restaurant table, can place an order from his/her tray. He/she also has the option to add the selected items to favorites.

### REFERENCE NUMERALS

100: The user. This generally refers to the end customer of a service provider.

102: Point of service. The location where service is rendered to the user.

104: User-service interaction space. The general area where a user obtains service from the service provider.

106: Mobile device, either owned by the user or by the service provider.

108: Point of service indicator. A visual indicator for the user to know of the existence of a point of service.

110: Service requests. The list of services that are requested by the user.

112: Web server.

114: Service provider's administration space. The area that is used by the service provider to administer and process a service request.

116: Service provider's staff.

118: Service provider's computer browser or a software application or printer or fax machine that indicates arrival or processing status of an order.

120: Notification of service request on a service provider's device (computer, printer, fax machine, or something similar).

122: Service fulfillment area such as a restaurant kitchen.

124: The process of provision of service.

300: The service provider's software application or hardware system.

302: The database server.

304: All data involved in the operation of the system, such as list of available services, pending orders, and so on.

400: The means for revealing user's location at a service point.

402: A list of services requested by the user.

404: Authentication of the service order and/or the user.

406: The module that fetches the list of available services from the data store.

410: The process of fulfilling the service request

### DETAILED DESCRIPTION

### General

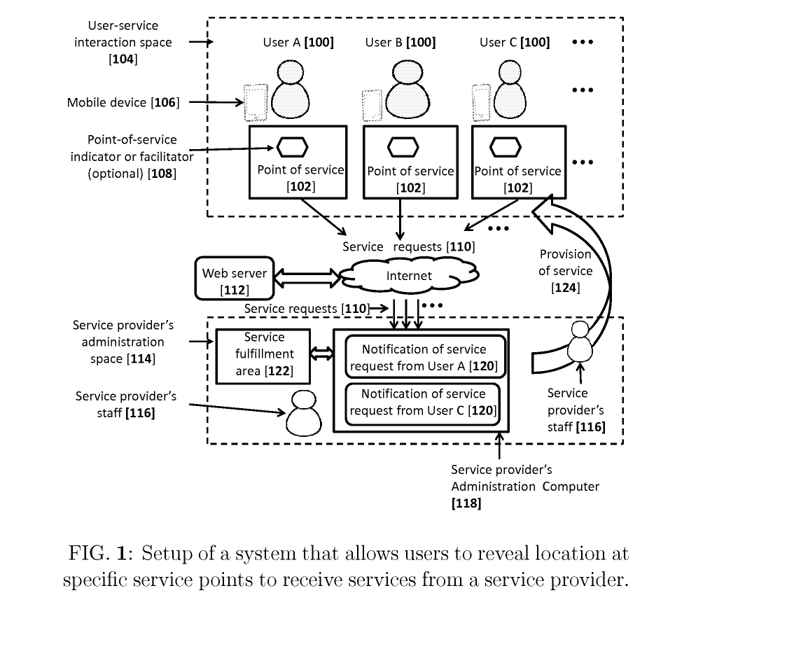

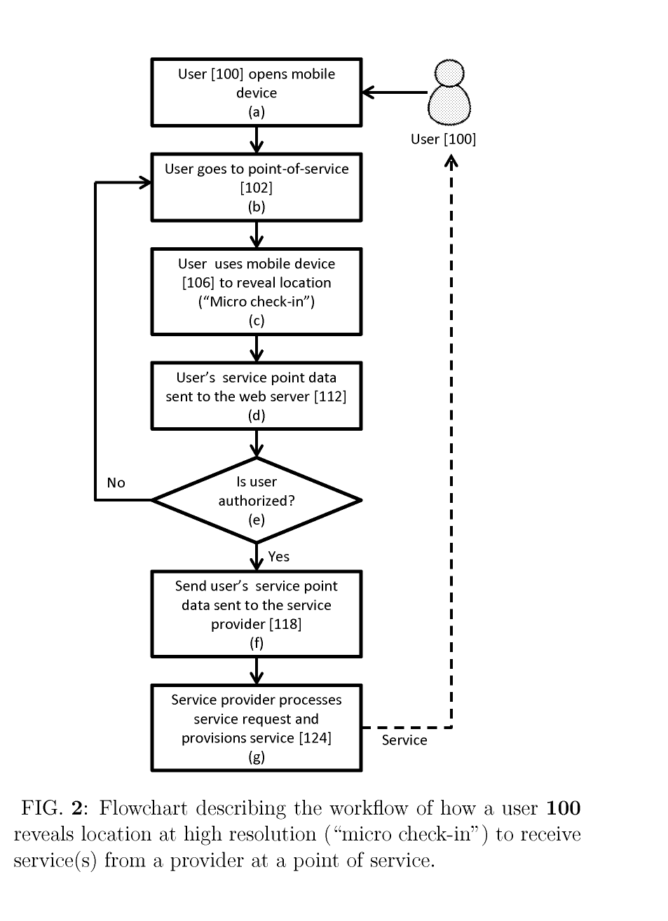

In this application, we disclose a system and method, depicted in FIG. 1 and FIG. 2, that allows a user 100 to reveal his or her presence at a designated service point 102 to a service provider. We introduce the concept of micro check-in, which is defined as framework which allows a user 100 to reveal his or her location selectively at a fine, well-defined, object or place at a resolution much finer than is possible by GPS or network based location sensors. For example, when location information is available based on GPS, one can deduce the location at the general area, such as a restaurant, park, or a mall. This is the limit on the accuracy of a GPS device today. This also limits the potential applications of such systems to cases such as social networking, and earning badges and rewards.

There are many more possibilities when users could selectively reveal their location to specific entities at a much finer resolution, the invention described in this application. Several new applications and/or new more efficient ways for existing uses open up with the described invention. Examples include but are not limited to checking in at a gym machine, a painting, an instruction board, a classroom desk, a museum exhibit, an airplane seat, an item for sale at a supermarket, a hotel room, steering wheel of a car, and so on.

Various applications and implementations are contemplated for one or more embodiments of the invention. Following are the main advantages of micro check-in over currently popular GPS based check-in.

1. Greater accuracy and precision: Micro check-in happens by a deliberate action of the user 100 (e.g., scanning a QR code), and hence it is both more accurate (high resolution) and precise (highly repeatable) in determining the location.
2. Defines a specific service point: By strategically placing the check-in points, one can define the specific service points that are relevant to the user 100 as well as the service provider. This is an important point to note: while micro check-in defines higher resolution of location, it does not allow check-in anywhere. This check-in must happen at a pre-defined service point 102. A restaurant table or a gym machine are two obvious examples, also discussed later.
3. New applications: We believe that several new applications will be enabled by micro check-in. These include new efficient ways of providing existing services, as well as entirely new possibilities not yet available. We discuss this in more detail below.

There are numerous cases where your specific location is crucial for a particular benefit or service. Below we list a few examples to illustrate the idea that several use cases require the knowledge of the precise location of the user 100.

1. To serve you, a full-service restaurant needs to know the exact table where you are. For the flight attendant to come to your seat to fulfill your request, he or she needs to know the seat number where you are seated.
2. To view winemaker's video introduction about a particular vintage, one needs to know the exact wine you are looking at.
3. To provide directions to a particular shop from a point where you are inside a mall, your exact location needs to be determined.

The aforementioned examples are but a few and the true implication of the invention should not be limited to the above. As is implied from the above ideas, there is a huge potential for technical and business innovations around the idea of micro check-in. Some of the above are improved ways of providing existing service (e.g., restaurant and flight seat check-in), while some others are entirely new possibilities (such as viewing wine-related video by checking-in on a specific wine).

These applications are critically based on defining specific service points to the user 100. In a typical micro check-in interaction, there are two entities involved, as discussed below.

1. Service provider: The service provider, typically a business or entity, defines the service points where users could check-in. Examples include an exhibit, a wine bottle, a restaurant table, and a gym machine.
2. User: The user 100 is the customer who gets the benefit of the service. This benefit is either due to improved efficiency or convenience, or is due to enhanced experience.
Both, the service provider and the user 100 will benefit by the improved efficiency or enhanced user-experience provided by micro check-in.

### Means of Enabling Micro Check-in

An important aspect of the overall benefit of micro check-in to the service provider and the user 100, is the way in which micro check-in is practically realized. There are more than one means 400 to enable micro check-in.

There are several factors that should be considered before choosing one technology over others, as listed below.

Cost: The adopted technology should not incur any costs to the users and it should be very inexpensive to use for the service provider.
Convenience: The effort that the user 100 needs to make to micro check-in must be minimal. At the same time, the setup for the service provider should be easy as well.
Accuracy: The accuracy of obtained location must be high, since it is a primary requirement for micro check-in.
Availability: The adopted technology should be widely available on the popular smartphone platforms.
User acceptance: Consumers must feel comfortable and be aware of the technology being used.
Keeping the above requirements in mind, we discuss, in the following, three most promising technologies (i.e., means 400) that can be used to enable micro check-in.

### Image Recognition

Image recognition is the field that includes methods for acquiring, processing, analyzing, and understanding images. Via the smartphone camera, user 100 can capture an image of an object of setup at the point of service 102. This image can be recognized by advanced image recognition algorithms, and thus it can be known by the authenticating party where the user 100 is.

Pros: The advantage in this method is that there is no additional setup needed at the point of service 102. Any setup can be linked to a specific information or data, using an application (such as LINKAPIC). This is well-suited to micro check-in applications related to artwork, exhibits, painting, wine label, and so on, where there already is a specific visual clue.

Cons: Due to the fact that there is no special setup needed, users may not recognize the existence of a service point 102. Often users need a clue about the existence of a service point 102 itself. This could lead to reduced usage. Another minor disadvantage of using image recognition for micro check-in is that it relatively less accepted among consumers.

### Near Field Communication

Near field communication (NFC) technology was conceived to bring mobile devices and physical objects together. It is a wireless technology for simplified transactions and data exchange between two devices in proximity to each other (within few centimeters). NFC is an extension/based on radio frequency identification tags (RFID) which are data chips that stores unique identification information on them that then can be read by an external data reader through the use of radio waves. NFC enabled smartphones provide a contactless transaction in which the user 100 only has to hold the smart-phone near the reader to access the data on the card.

Pros: The technology provides high accuracy as well as convenience at the same time. If the user 100 has an NFC-enabled device he or she can micro check-in very easily. Bulletin boards and smart posters are potential use cases.

Cons: There is a specific setup required on the part of the service provider, whose cost is not trivial. Moreover, the security implications of any RFID based technology could be serious. The main disadvantage is the lack of user acceptance. At the time of writing, only a few commercially available smartphones have NFC technology enabled.

### Quick Response Code

A quick response code (QR code) is a two dimensional barcode designed specifically to be read by camera phones (and dedicated barcode readers). Based on the type of code it is, it might direct the viewer to a website, make a phone call, or do other actions. The code consists of black modules arranged in a square pattern on a white background. The information encoded can be made up of any kind of data. Users have to download a QR code reader to use them to access all kinds of information including web addresses, personal or professional contact information, or Internet landing pages.

Pros: QR code is based on an open format whose specification is available royalty-free. It is compact, error tolerant and responds quickly. The main advantage is that it has a growing acceptance among consumers. Although initial setup is required by the service provider, the costs are quite low (printing and setup). Since most mobile phones have a camera, the technology is available to a majority of mobile phone users. The presence of a QR code also gives the user 100 of the presence of a service point 102.

Cons: One major disadvantage of QR codes is its aesthetics. At many service points, the aesthetics of the arrangement is crucial and the service provider may not want to put an ugly looking QR code there.

### Operation—General

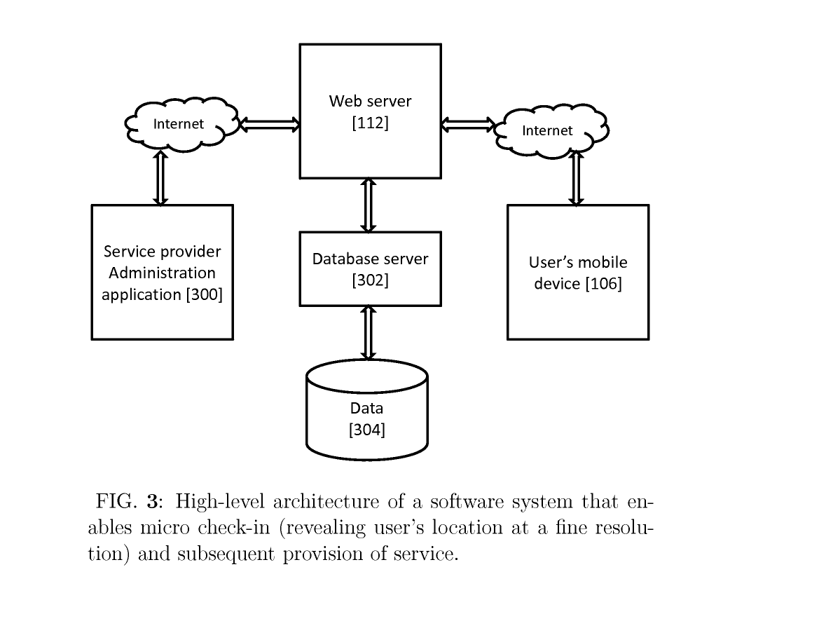

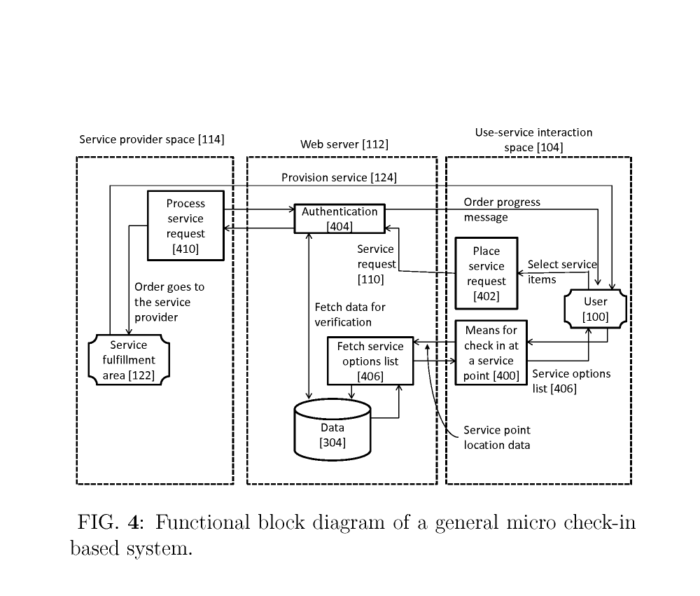

FIG. 1 shows the setup of the system described in this application. As stated earlier, this system and method is referred to as micro check-in. FIG. 2 explains the system in the form of a flowchart. High-level architecture of the system is presented in FIG. 3. The functional blocks are explained in FIG. 4. In the next paragraphs we explain the operation of the micro check-in system using these figures (FIG. 1-FIG. 4).

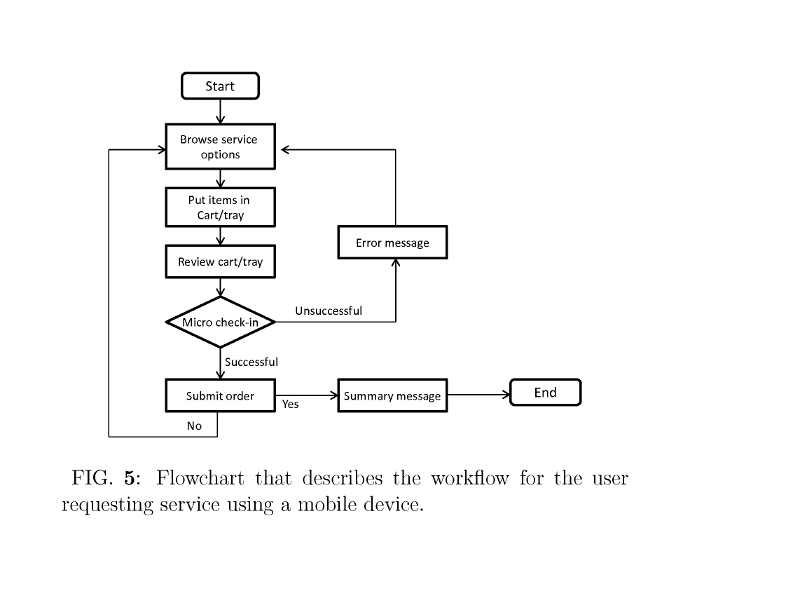

The system involves a specific designated area that is typically under the control or administration of a service provider 116. This area is the user-service interaction space 104 and is usually the physical space where the service 124 is rendered to the user 100. The user 100 is typically the customer of the service provider 116. By one of several possible means 400, a user 100 reveals his or her location at a pre-designated service point 102. The service point 102 is a finely-defined area that typically is also the physical space where a service 124 is rendered. The service point 102 optionally has a visual indicator or facilitator 108 of the presence of a service point 102. The workflow for the user 100 is shown in FIG. 5. The user 100 uses a mobile device 106 to reveal his or her location at the point of service 102 via the optionally placed point of service facilitator 108. This action of the user 100 allows him or her to see a list of available services 406. The user 100 then chooses the services he or she would like to receive and place the order via the mobile device 106. The service requests 110 are passed to a central web server 112 via the Internet. The server authorizes and authenticates the user (404 and FIG. 2(e)) and forwards the requests to the service provider's computer or device 118.

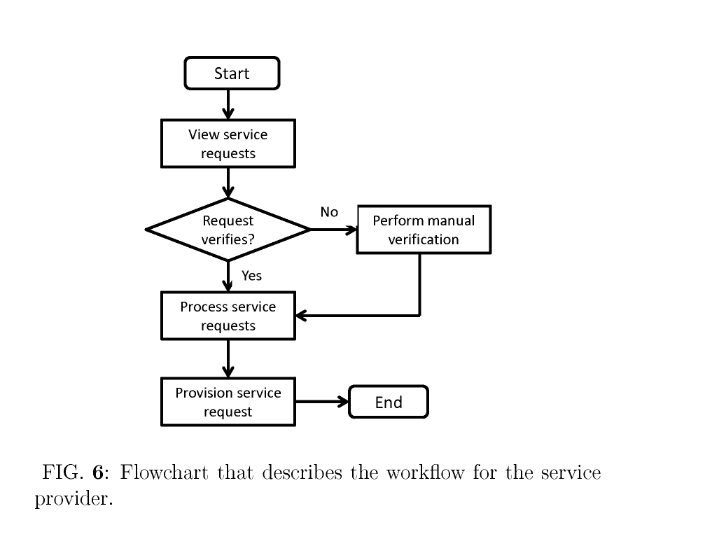

The workflow for the service provider 116 is shown in FIG. 6. In one embodiment, the service provider's staff 116 sees the service requests 110 on their computer as a notification 120. In general, human staff may or may not be involved in rendering the service. The service requests 110 are processed by the service provider 116 at a service fulfillment area 112. Finally the service is provisioned 124 to the user 100. The system architecture at a high level is depicted in FIG. 3. One or more web servers 112 and one or more database servers 302 drive the system for both the user 100 and the service provider 116. A software application or web application on a mobile device 106 form the communication point for the user 100. In one embodiment, a software application or a web application 300 on the service provider's computer 118 receives the service request from the web server, and also assists in managing the progress in provisioning the service. In another embodiment, the service provider simply uses a printer or a fax machine to obtain the service requests 406. The database server 302 manages and maintains all the data 304 pertaining to the application, including but not limited to list of rendered services, list of available services, a log of users, users' favorite services, and so on.

In FIG. 4 we provide various functional modules that form one general embodiment of the invention. The user 100 first uses a means of check-in 400 at a service point 102 to reveal his or her location. Via a web server 112, this request goes to the database server 302, that accesses the data 304 and provides a list of available services 406 to the user 100. The user places a service request 402 that goes to the service provider via a authentication module 404 at the web server 112. The service provider processes the request 410 at the service provider's space 114 and provisions the service 124. The service is typically processed at a service fulfillment area 122 within the service provider's administration space 114.

### Detailed Description of the First Embodiment

Having described the system in general in previous sections, we now discuss the invention with a specific embodiment {that of a system that allows patrons (users 100) to order food using their mobile devices 106 while sitting at a restaurant table (point of service 102). This allows the user to place an order without directly interacting with restaurant wait staff, thus saving the time of both the restaurant (service provider 116) and the user 100 as a result of the improved efficiency.

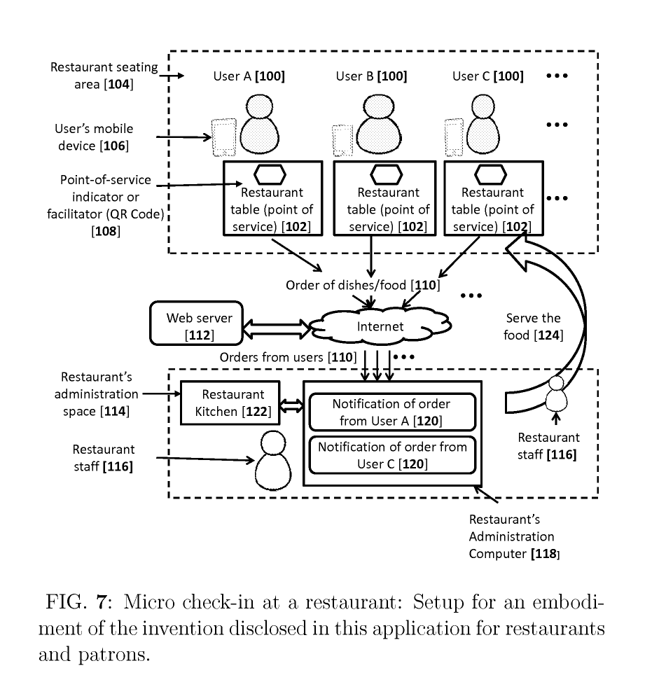

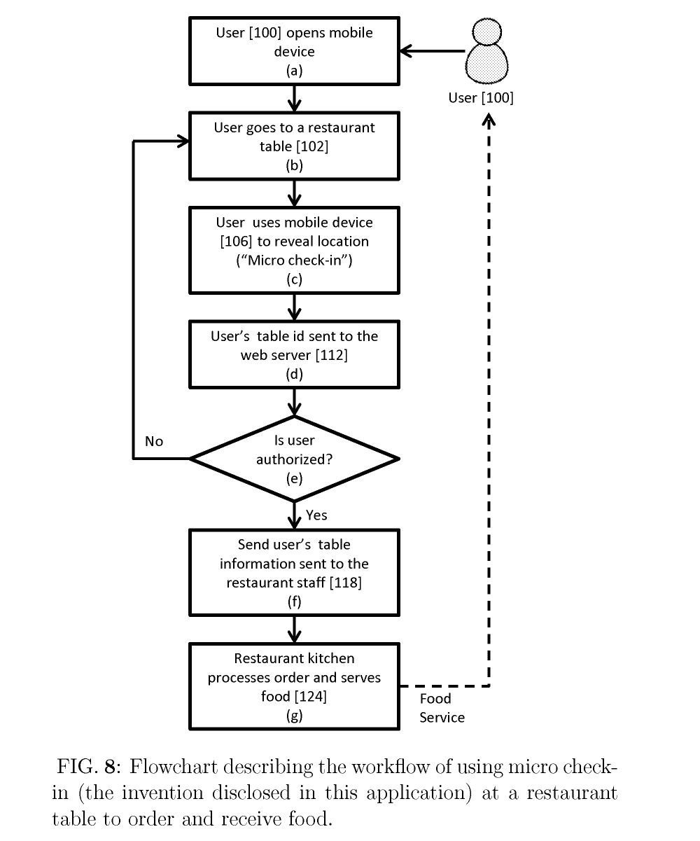

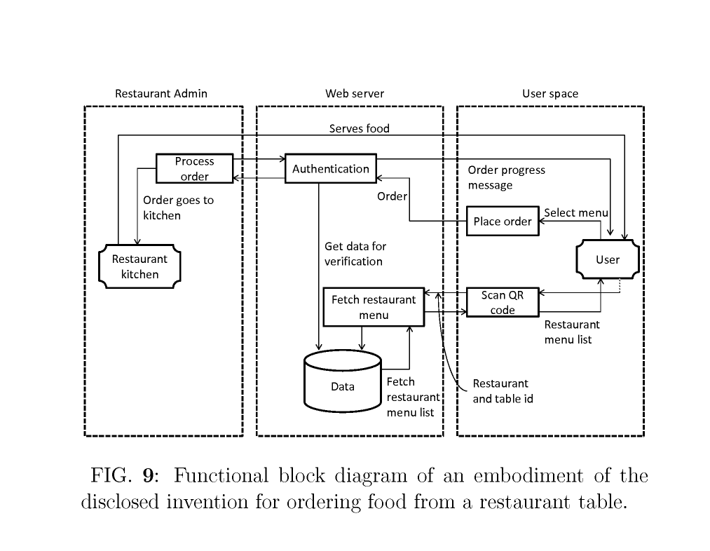

The system and method for this embodiment is described in FIG. 7, FIG. 8, and FIG. 9. There are two components in this design. First, a smartphone application (Andriod, iPhone, or other) which allows users 100 to micro check-in via QR codes 400 and order food 402, and second, a web admin application 300 for the restaurant staff 116 that allows them to manage menu and process orders. There is a central web server 112 that links the two. The mobile 106 application communicates with the web server 112 in real-time and exchanges the information related to orders placed 402 from a table 102. The web server 112 also communicates with the restaurant administration web application 300 about the orders placed 402, and any menu updates.

The high level architecture of the system shown in FIG. 3 illustrates how the system for this embodiment is designed. The customer 100 scans a QR code (a mean of revealing location 400) to place an order 402 using their smartphone 106. When the order is placed, the application calls the web server 112 with the unique table id, time, date, and order details. After that, the web server validates the order (i.e., authenticates and authorizes 404) by verifying the order information. To verify the information, web server accesses data 304 from database server 302. If the order information is invalid, web server rejects the order and sends specific error message on user's mobile phone 106. On the other hand, if the order information is valid, the web server 112 calls restaurant web application 300 and provides valid data. The web application will then display order information on screen or printout 118 and notifies a new order request 120.

FIG. 9 illustrated the functional block diagram of this embodiment. There are three major parts of the application including user space 104, web server 112, and restaurant administration space 114. Within user space, the user 100 can perform two tasks. One is, a user can request for restaurant menu by scanning a QR code 400. Then that user space calls web server with the menu request along with table id and restaurant name. The web server 112 verifies the data and pulls correct menu based on unique restaurant id/name and replies back. If the menu is already in the user's smartphone's cache, and there are no updates to the menu, it is not updated.

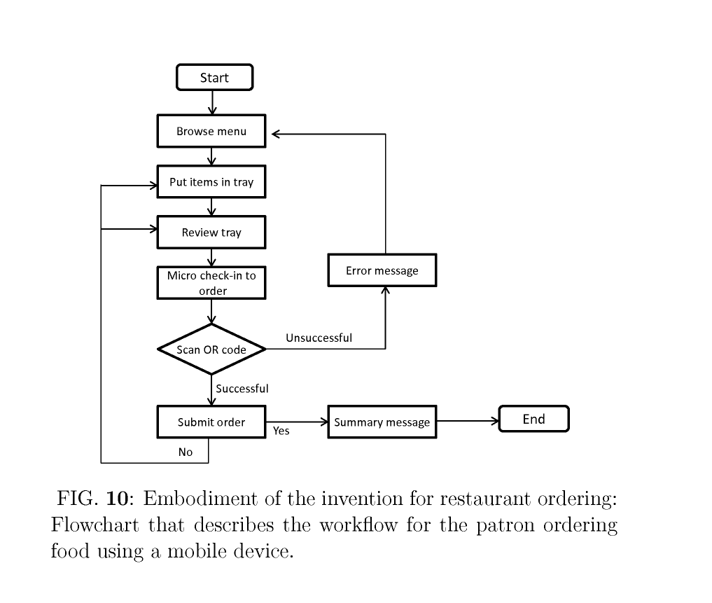

Another task is, a user can select items from menu and place the order 402 by scanning a QR code 400. This process sends the order directly to web server 112. Then the web server authenticates 404 the order information by pulling data 304 from database server. After a successful authentication, web server 112 sends the order right to the restaurant administration application 300. The restaurant staff 116 now sends the order to the restaurant kitchen 122. Once ready, the food 124 is served at the table 102. FIG. 10 illustrates the mobile application flow diagram for the user 100. Once the application starts, the user 100 can browse the menu for nearby restaurants. The restaurant list is fetched based on the user's current GPS location. While browsing menu, the user can put items in tray if they want to order. After that, users can review the tray and finalize the order. To place the order, users micro check-in to a restaurant table 102 by scanning a QR code 400 available at a restaurant table. If there is an error during QR code scanning, the error message screen will be displayed and it will redirect the user to browse menu screen. Otherwise, the user can submit the order by pressing a submit button on the screen. The user 100 will get a chance to decide before finally placing an order. If they decide to order, on success the greetings message will appear on the screen and application will end otherwise the user can go back to review the tray or select new items.

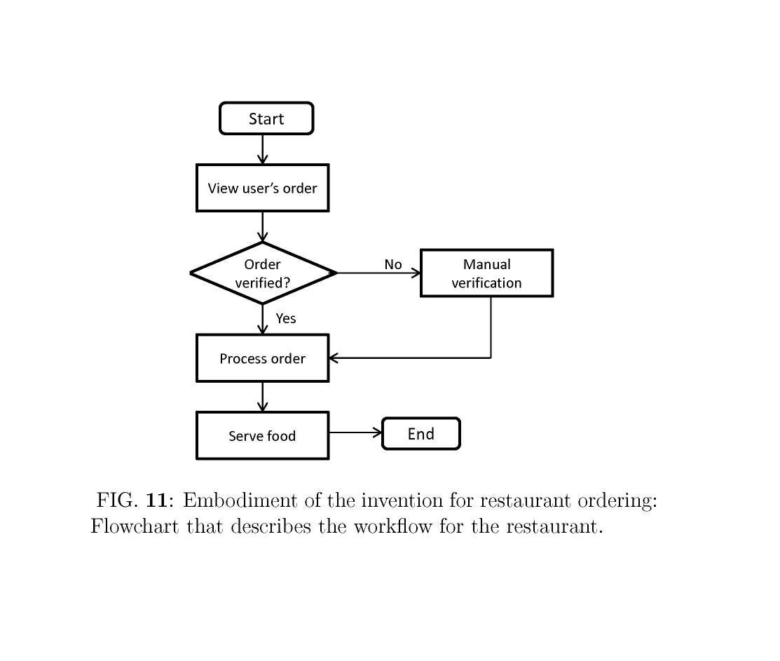

FIG. 11 illustrates the restaurant administration application diagram. After a successful administration login, the home page for order information is loaded. If a new order arrives, the order color is changed and restaurant staff 116 can verify the order information 110. After a successful verification of order 404, the order information goes to the restaurant kitchen 122. Otherwise, the manual verification is done and then order information goes to restaurant kitchen 122. After a successful order, the wait staff 116 serves the food 124 at restaurant table 102 and order information is stored in database 304. Example interface wireframes: We now present a few mockups for an application (referred to by the name OnTable in the figures) that the user 100 can see on his or her mobile device 106. These and other mock-ups (wireframes) are presented as example user interfaces to illustrate this embodiment of the invention. These should not be considered as limiting the embodiments of the presented invention, since many other interfaces can provide the same functionality using the invention.

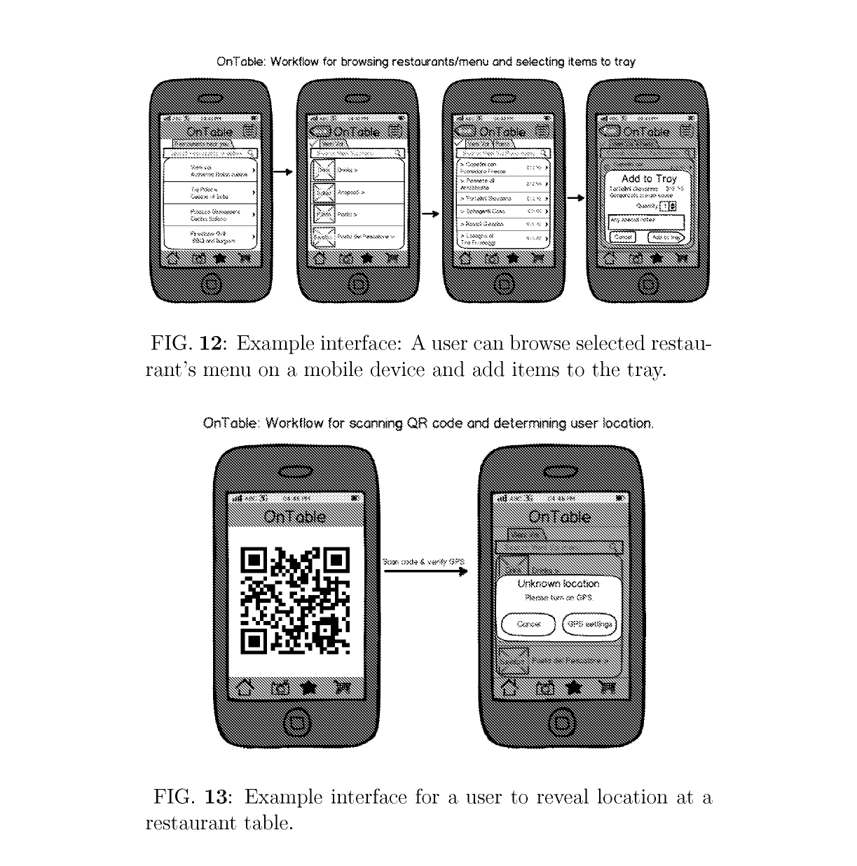

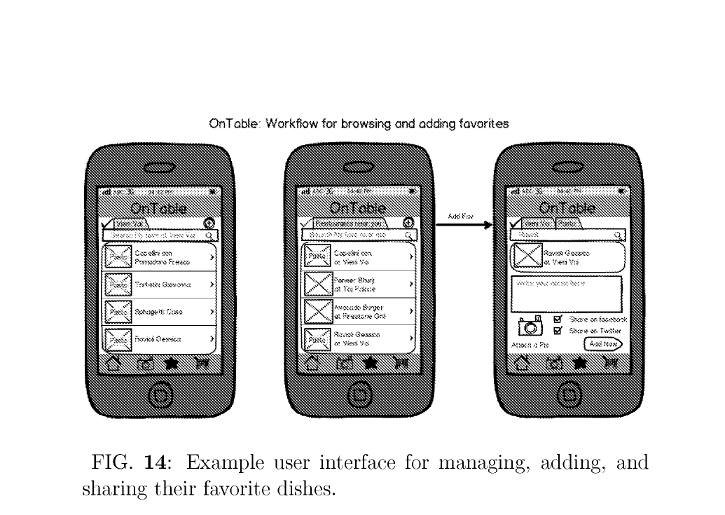

The FIG. 12 illustrates an example interface for the mobile application. The home screen displays restaurant names based on users current GPS location. Users can select any restaurant and browse the menu. They can also select items and add them to order tray. FIG. 13 shows an example of how to micro check-in 400 to a restaurant table 102. To authenticate 404 user's current location, a web server 112 verifies current GPS location of the user 100. User should enable his/her smartphone's GPS to pass a web server authentication 404 successfully.

The FIG. 14 shows how a user 100 can store his/her favorite items using the restaurant embodiment of the invention. User 100 can search the menu or browse the menu to add a favorite item. It can also be added from a tray. When a user is know to be at a given restaurant the location is verified by QR code check-in 400. Whenever user is not at a specific restaurant 104, all favorites will be shown.

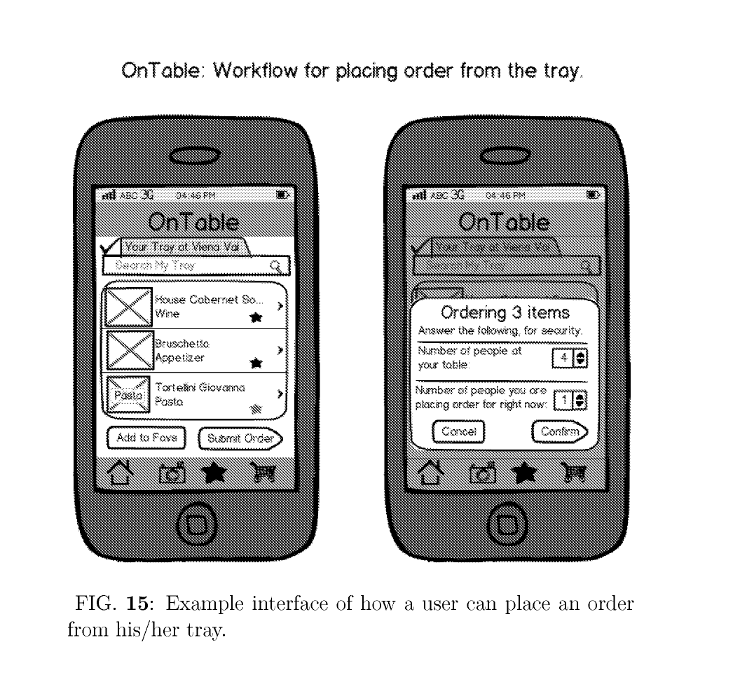

The FIG. 15 shows an example of placing an order from the tray using the shown embodiment. While placing order, a user is assumed to be already checked-in to a restaurant table, otherwise is prompted to scan the QR code. User can add his/her favorites at any time. Now, once the user decides what to order, he or she will see the order confirmation screen. The application will ask user to confirm the number of people they are ordering for and the number of people at the table. This provides additional security to the application. This type of security is just an example.

Advantages and benefits: The embodiment of the invention for restaurant ordering system provides several benefits to the restaurants 116 as well as to the users 100. From the business perspective, the restaurants are the customers of this service, since they will be paying a nominal service fee for providing the enhanced ordering service to the users. Benefits to the restaurants: This embodiment for restaurants provides great value by increasing customer satisfaction.

Below is a list of potential benefits of using the invention described in this application to the restaurants.

1. Quick turnaround: Due to improved overall efficiency, the restaurants can server more customers in a given amount of time.
2. Offer better service: The restaurant staff is freed up from essentially repetitive work of taking order and punching into a POS system. This allows them to engage better with the customers.
3. Fewer error: Since the order from the customer reaches directly to the POS or responsible staff there are fewer avenues of error.
4. Analytics: Restaurants can easily know and analyze the dishes that customers like (add to their favorites) and share most often.
5. Engage customers: Restaurants have a platform to better engage with customers by pushing special offers and deals.

Benefits to the users: The end users also get an enhanced overall experience, due to the following benefits.

1. Order when ready: Customers will have an optimum ordering experience because they can order right when they are ready, not when the server comes to ask. Sometimes users are not yet ready, and sometimes they have been waiting for a long time.
2. Save or order from favorites: Users often order a selected few dishes that they like. There is no easy method available today for them to keep track of their favorites. Now, with this invention, users can not only keep track of their favorites, but be able to quickly order.
3. Share favorites and get recommendations: Eating out can become even more social with the ability for users to share favorites with their friends, and in turn, get good recommendations from them.
4. Per-dish ratings: The rating sites popular today (e.g., YELP) has a very crude rating system broadly averaging determining the quality of a restaurant. When ratings are available per dish (menu item) users can search for the item they crave and pick the best restaurant for that dish. This is also beneficial for the restaurants since there are some specific dishes that a restaurant specializes in, which can be better revealed using this system of rating rather than average rating for the restaurant.
5. Get specials and discounts: Users can get specials and discounts, tailored to their favorites, right on their smartphone.
6. One app for all restaurants: Users just have to maintain and use one application for all their eating out use cases (find dishes, restaurants, recommend favorites, order food when at a restaurant, and immediately rate the dish).

From the above discussion it is clear that this embodiment can provide great benefits to both the users and the restaurants. We believe that there is a good business case for this application. This embodiment is just one case of how the presented invention, which involves system and method for revealing location at a service point, can open up new applications. In the following section we discuss many other embodiments of the invention.

### Other Embodiments

Below we discuss several other embodiments that follow the general setup described in FIG. 1-FIG. 4.

At a gym: Most modern treadmills and similar equipment allow users to keep track of some essential statistics such as distance traveled, calories burnt and heart rate. However, manually keeping track of these statistics on daily basis is difficult. Micro check-in can solve this problem by allowing users to check-in at a gym machine and getting daily statistics wirelessly. The gym plays the role of the service provider 116, their customers are the users 100, and the gym machines are the point of service 102. The gym staff 116 would need to set up the system that can allow getting the statistics from a gym machine 102. QR codes or image recognition could be the appropriate enabling technology 400 for micro check-in. Image recognition could be useful even in cases where the machine is not networked. The statistics could be captured from the picture of the information screen. QR code would be more appropriate when the machine is networked and the information about the machine id and the time would be enough to get the statistics.

At a museum: With the emergence of digital technology, museums adapted digitized way of sharing information via virtual exhibits. These digital exhibits have plethora of information not readily available at the actual museum exhibit. With micro check-in, users can check-in at a museum artifact and get this information available digitally (history, video, brief documentary, wikipedia article, and so on). Users can also store the information, enjoy it later, and share with friends and family. The museum staff 116 is the service provider here, the visitors are the users 100, and the exhibits are the point of service 102. The museums in most cases have already made efforts creating enhanced content related to popular exhibits. As means 400 of enabling micro check-in they simply have to place QR codes or in case of image recognition, do nothing other than educating users. QR codes have the benefit of the users 100 easily recognizing the location of the point of service 102.

At a classroom: Learning in a classroom can be made more interactive and fun if the students can obtain illustrations and other information in their mobile devices (e.g., smartphones or tablet computers) by micro check-in at a desk in the classroom. In this embodiment, the students are the users 100, the desk is the service point 102, and the teacher (and/or the school) is the service provider 116. The classroom is the user-service interaction space 104.

At a mall or amusement park: We often need to go to some specific shop or ride from where we are (i.e., we need specific directions within a mall or an amusement park). The GPS receivers do not work well inside the malls, so there is no good way to get the directions other than looking at the maps inside the mall or the amusement park. This problem can be addressed using micro check-in. The staff can define several points within the mall or amusement park where users can micro check-in (say, via QR codes) to reveal their location and in turn receive the directions to the place they want to be. In this case, the people are the users 100, the defined points are the service points 102, and the mall/amusement park is the service provider 116. The whole area within the mall could be the user-service interaction area 104. The means of revealing location 400 is using QR codes, although image recognition or radio tags could be used in an alternative embodiment.

In an airplane: When we are seated at a seat in an airplane, we often need to be served since getting up from the seat to request the service is not allowed or is not convenient. People have to wait to call a airplane host passing by, or use a button to request service. With micro check-in a user can reveal his location at a seat and request the desired service. The airplane host or hostess can see the request and provision the service in the most efficient manner. This saves time for both the air travelers and the service staff. In this embodiment, the air traveler is the user 100, the staff is the service provider 116, the seat is the point of service 102, and the airplane is the user-service interaction area 104.

At a grocery or other store: We have to go through a lot of hoops when buying at a grocery or general store. We have to punch loyalty cards as well as a credit card in order to complete the purchase. This process can be simplified by using micro check-in at the check-out counter at the grocery or other store. User can micro check-in (reveal his or her location) at the check-out counter to see the bill and pay using his or her mobile device (such as a smartphone). The loyalty card can be applied easily using the user's authentication information. In this case, the grocery store is the user-service interaction area 104, the customer is the user 100, the store is the service provider 116, and the means of micro check-in 400 could be a QR code or NFC.

At a casino: People use loyalty cards at a casino and need to give the card for swiping every time they sit at a casino gaming table. This inconvenience can be addressed by micro check-in at the gaming table. The casino staff can also provide drink service via this same service. Also, similar to the mall application mentioned above, the same application can provide directions to users when they are trying to find their way inside the casino. In this embodiment, the casino visitors are the users 100, the gaming tables (or various points in case of directions application) are the service points 102, and the services being provided include loyalty tracking and/or directions or other experience-enhancing services.

At a sporting event: When we go to watch a game and need a drink or snack, we often have to interrupt the game to go and get it. By revealing their location (i.e., micro check-in) at the seat people can place orders for service such as drinks or snacks without going away from their seats. The staff will know exactly which seat number the order came from, and can fulfill the order right away and either serve the food/drink, or notify on the user's phone when the order is ready for pickup. In this case, the audience is the user 100, the seat is the service point 102, the stadium is the user-service interaction area 104, and the catering staff is the service provider 116.

At a theater: The situation at a theater (movie or otherwise) is similar to a sporting event, where the audience can micro check-in to place and receive orders rather than going to the service station and standing in a queue to buy drinks or snacks. In this embodiment, the customers are the users 100, the seat is the point of service 102, and the catering staff is the service provider 116.

The above list provides some of the promising applications of the proposed invention. These should not be considered as limiting the potential of the invention, as there would be many more embodiments that would be practically useful.

### CONCLUSION

In this application, we describe a method and system for obtaining services at a service point using a mobile device. Although the illustrative embodiments of the invention have been described in detail herein with reference to the accompanying drawings, it is to be understood that the invention is not limited to those precise embodiments. As such, an modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. This, the absence of describing combinations should not preclude the inventor from claiming rights to such combinations.

What is claimed is:

1. A method for enabling provision of service by a service provider to a user within a commercial establishment using a mobile device;
the method comprises:
1. the said user revealing his presence at a specific finely defined object or place in a commercial establishment to a service provider using mobile device for the purpose of obtaining desired service(s);
2. the said user making a selection of service from a list of available services;
3. the said user requesting one or more desired service(s) from the said list of available services via the said mobile device;
4. the said service provider fulfilling the said service request to the said user.

2. The method of claim 1 wherein method comprises the said commercial establishment designating one or more point(s) of service where the said user seeks services of the said service provider.

3. The method of claim 1 wherein the method comprises providing one or more mean(s) of revealing the presence of the user at one of the said point(s) of service using said mobile device.

4. The method of claim 1 wherein the method comprises providing a list of available services to the said user by the said service provider which is stored in a computer storage device.

5. The method of claim 1 further comprising means for the service provider to offer customizations to the available services to the said user, and a means for the user to select from the service customizations offered by the service provider.

6. The method of claim 1 further comprising providing a means of verifying the validity of the said user's service request by verifying one or more of: the user's location obtained using the GPS receiver of a mobile device, information about the service point that can be known only by someone who is at the said service point, and information that can be manually verified by the service provider to perform verification of the said user's request.

7. The method of claim 1 wherein the method comprises the said service provider fulfilling the said service request to the said user; whereby the said service request gets sent to the said service provider by eliminating direct in-person communication between the user and the service provider staff.

8. The method of claim 1 wherein the method comprises the step of delivering a completed order or in case of unavailability of requested service, informing said user about unavailability of said requested service to the mobile device of the said user.

9. The method of claim 1 wherein said method comprises of said user having a mobile device, said method comprising a list of available service(s) uploaded from a data device of said commercial establishment to an internet server, the list of available services downloaded from the server to the mobile device of the said user through a mobile application or an internet site; the said mobile application or the internet site being such that the user can use his mobile device to access the list of available services.

10. The method of claim 1 wherein, a completed order is uploaded to the web server of the said service provider via the mobile device of the said user; the said order being associated with a unique order ID code being generated and stored on the internet server and/or the user's mobile device.

11. The method of claim 1 wherein the current order is stored as past food order associated with said user.

12. The method of claim 1 wherein upon receipt of the order by said service provider, the said user receives an acknowledgment from said commercial establishment data server.

13. The method of claim 1 further comprising providing means for the said user to save their favorite services and retrieve them at a later time.

14. The method of claim 1 further comprising providing means for the said user to provide rating and reviews for the services.

15. The method of claim 1 wherein upon fulfillment of said request service by said service provider, the mobile device displays a thank you.
